(19) United States
(12) Patent Application Publication
(10) Pub. No.: US 2010/0140850 A1
(43) Pub. Date: Jun. 10, 2010

(54) Compositions for 3D printing

(75) Inventors: Eduardo Napadensky, Natania (IL); Diana Ravich, Natania (IL)

Correspondence Address: MARTIN D. MOYNIHAN d/b/a PRTSI, INC., P.O. BOX 16446, ARLINGTON, VA, 22215, US

(73) Assignee: Objet Geometries Ltd., Rechovot (IL)

(21) Appl. No.: 12/591,903

(22) Filed: Dec. 3, 2009

Related U.S. Application Data
(60) Provisional application No. 61/119,744, filed on Dec. 4, 2008.

(51) Int. Cl. B29C 35/08; C08F 2/46

(52) U.S. Cl. 264/401; 425/174.4; 522/71; 522/79

(57) ABSTRACT

Described is a composition for solid freeform fabrication (SFF) at a given dispensing temperature. The composition comprises: a curable component having a monofunctional (meth)acrylic functional group; a photo-initiator, and a sulfur-containing additive. The viscosity of the composition, as measured at the given dispensing temperature, changes by no more than 3 cps during 30 days of aging at 40° C.

### FIELD AND BACKGROUND OF THE INVENTION

The present invention, in some embodiments thereof, relates to compositions for solid freeform fabrication (SFF) and, more particularly, but not exclusively, to compositions useful in three-dimensional printing.

Solid freeform fabrication processes are defined as processes in which objects are constructed in layers utilizing a computer model of the objects. The layers are deposited or formed by a suitable device which receives signals from a computer using, e.g., a computer aided design (CAD) software.

Solid freeform fabrication is typically used in design-related fields where it is used for visualization, demonstration and mechanical prototyping. Thus, solid freeform fabrication facilitates rapid fabrication of functioning prototypes with minimal investment in tooling and labor. Such rapid prototyping shortens the product development cycle and improves the design process by providing rapid and effective feedback to the designer. Solid freeform fabrication can also be used for rapid fabrication of non-functional parts, e.g., for the purpose of assessing various aspects of a design such as aesthetics, fit, assembly and the like. Additionally, solid freeform fabrication techniques have been proven to be useful in the fields of medicine, where expected outcomes are modeled prior to performing procedures. It is recognized that many other areas can benefit from rapid prototyping technology, including, without limitation, the fields of architecture, dentistry and plastic surgery where the visualization of a particular design and/or function is useful.

Various solid freeform fabrication techniques exist. One such technique, known as three-dimensional printing is disclosed variously in, e.g., U.S. Pat. Nos. 6,259,962, 6,569,373, 6,658,314, 6,850,334, 6,863,859, 7,183,335, 7,209,797, 7,225,045, 7,300,619, 7,364,686, 7,500,846 and 7,604,768, and PCT Publication No. WO 2009/013751, all of the present Assignee, the contents of which are hereby incorporated by reference. In this technique, building materials are selectively dispensed from a printing head having a set of nozzles to deposit layers on a supporting structure, e.g., a printing tray. Depending on the building materials, the layers are then cured using a suitable curing device. The building materials may include modeling materials and support materials, which form the object and the support constructions supporting the object as it is being built.

U.S. Pat. No. 7,183,335, assigned to the assignee of the present application, describes compositions for use in the manufacture of three-dimensional objects. In accordance with this patent, a composition suitable for building a three-dimensional object may include a curable component, a photo-initiator, a surface-active agent and a stabilizer. The composition may further include a curable compound, which is a sulfur-containing component. In one embodiment, the sulfur containing component is beta mercaptopropionate, mercaptoacetate, alkane thiols or any combination thereof. The addition of sulfur-containing components is described to significantly enhance the composition reactivity at levels of about 5% of sulfur-containing component.

U.S. Pat. No. 6,242,149 describes a fast-curing photosensitive composition that is used in recording inks, materials encapsulated inside photocuring microcapsules for image recording, photosensitive coating compositions, and the like. The composition comprises a radical-polymerizable unsaturated compound, a photopolymerization initiator, and a thiol-containing compound, whereby the fast-curing photosensitive composition can be adequately cured with low exposure energy.

### SUMMARY OF THE INVENTION

UV curable acrylic based compositions for SFF, for example FullCure®720 (from Objet Geometries Ltd, Israel) have a characteristic yellow tint. In some UV curable compositions, the yellow tint is present both before and after curing, while in other compositions, the yellow tint appears only during the curing process. Although the source of the yellow tint is not completely understood, the photoinitiator type and concentration influence the resulting material color. While some photo initiators have a strong color, e.g., I-369, resulting in an undesirable material color even at low photo initiator concentrations, other photo initiators, e.g., Darocure TPO, have much less color, but are required to be used at high concentrations in order to impart the composition sufficient reactivity, thus also resulting in a negative impact on the cured material's color. Other color sources are the color of the raw materials themselves, raw material contaminations as well as additives, e.g., radical scavengers, added in order to impede polymerization of the raw materials during the production process or in order to impede spontaneous polymerization over time during storage.

In addition to the undesirable yellow tint produced by the use of photoinitiators at high concentrations, high photoinitiator concentrations also have a negative affect on the cured material's mechanical properties. For example, a high photoinitiator concentration tends to produce materials with inferior mechanical properties, such as lower tensile strength, compared to the tensile strength of the same material with a lower concentration of the respective photoinitiator. Relative tensile strengths are exemplified hereinunder.

The present invention, in some embodiments thereof, relates to compositions for solid freeform fabrication (SFF) and, more particularly, but not exclusively, to compositions useful in three-dimensional printing.

An aspect of some embodiments of the invention concerns a composition for solid freeform fabrication at a given dispensing temperature, the composition comprising:

a curable component having a (meth)acrylic functional group;

a photo-initiator, initiating polymerization of the curable component when exposed to radiation; and

a sulfur-containing additive,

wherein the viscosity of the composition changes by 3 cps or less during 30 days aging at 40° C., the viscosity being measured at the given dispensing temperature. Optionally, the given dispensing temperature is higher than room temperature, for example, between about 40° C. and about 100° C., and optionally at about 75° C. or lower. In a preferred embodiment, the temperature is about 75° C.

In various exemplary embodiments of the invention the viscosity is measured using a Brookfield LVDVE viscometer equipped with a 25 mm spindle (Brookfield Engineering Laboratories, MA, USA).

Optionally, the photo-initiator concentration is such that the composition is colorless before curing.

Optionally, the radiation is light radiation, for example, UV or VIS radiation.

Optionally, the composition also comprises a surface active agent.

In an exemplary embodiment, the composition provides, upon curing, a solid with lighter yellow hue than the hue of a solid obtained by curing the same composition, but without the sulfur-containing additive.

In exemplary embodiments, the sulfur-containing additive constitutes up to 4% or up to 4.5% or up to 3%, or up to 2.5%, or up to 2.0%, or up to 1.5%, or up to 0.5% of the composition, and preferably about 1% of the composition.

The composition of the present embodiments facilitates high-quality fabrication of finely detailed objects. In some embodiments of the present invention, the composition allows SFF with a resolution that is at least sufficient to distinguish between cured three-dimensional features (e.g., linear features, about 1 mm in thickness) that are less than X mm apart, where X equals 0.3 or 0.29 or 0.28 or 0.27 or 0.26 or 0.25 or 0.24 or 0.23 or 0.22 or 0.21, under normal operation conditions of the SFF apparatus for example, the 3D printer.

In some embodiments, the reactivity of the composition is higher that the reactivity of a composition which comprises the same components but without the sulfur-containing additive. Optionally, the sulfur-containing additive adds more than 10% to the reactivity of the composition.

In some embodiments, the composition has a reactivity of at least 50% on a scale, referred to herein as the “Menifa” scale and defined hereinunder. In some embodiments, an identical composition but without the sulfur-containing additive has a reactivity of less than 30%.

It has been found by the inventors of the present invention that the composition becomes more stable if it contains at least 30% mono (meth)acrylic monomer. Thus, in some embodiments of the present invention the composition comprises at least 30% mono (meth)acrylic monomer. It was also found that compositions having more than 70% mono (meth)acrylic monomer have too low viscosity. Thus, in some embodiments of the invention, the curable component comprises from about 30% to about 70% mono (meth)acrylic monomer, and the rest di (meth)acrylic oligomer.

In some embodiments, upon curing, the composition provides a solid with tensile strength greater than that of a cured composition having similar reactivity and which includes substantially the same components, but without the sulfur-containing additive and with a higher photo-initiator content for restoring the requisite level of reactivity. For example, some compositions of the present embodiments which are ‘glassy’ (e.g., they have glass-transition temperature (Tg) higher than room temperature) that comprise a photoinititiator at a concentration of 1% have a tensile strength of 20 MPa or more, for example, 35 MPa, while similar compositions without the sulfur-containing additive but with a higher photoinititiator concentration (which is required to provide a similar i.e., higher level of reactivity) for example 5%, have a tensile strength which is below 20 MPa.

Tensile strength can be measured using Lloyd LR5K material testing machine (Lloyd Instruments Ltd., UK), or equivalent thereof.

Optionally, a composition according to the present invention comprises two photoinitiators, having absorption peaks at different wavelengths, to utilize a broader radiation spectrum of light provided by the 3D-printer, and to allow penetration of light of longer wavelengths into the bulk of the irradiated composition.

An aspect of some embodiments of the invention concerns a method of forming a three-dimensional object, the method comprising:

dispensing a composition for solid freeform fabrication from a printing head; and

curing or at least partially the dispensed composition,

wherein the composition is according to any of the embodiments delineated hereinabove and further detailed hereinafter.

Unless otherwise defined, all technical and/or scientific terms used herein have the same meaning as commonly understood by one of ordinary skill in the art to which the invention pertains. While exemplary methods and materials are described below, methods and materials similar or equivalent to those described herein can be used in the practice or testing of embodiments of the invention. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a three-dimensional printing system, which can be used in some embodiments of the present invention;

FIG. 2 is a schematic cross-sectional illustration of the construction of a three-dimensional model of a bowl, according to some embodiments of the present invention; and

FIG. 3 is a schematic illustration of a pattern useful for determining reactivity of a composition according to an exemplary embodiment of the invention;

FIG. 4 is a photograph of two patterns printed with compositions for determining their reactivity according to an exemplary embodiment of the invention; and

FIG. 5 is a graphic representation of comparative use of different percentages of sulfur containing additive, obtained in stability measurements performed according to an exemplary embodiment of the invention.

### DESCRIPTION OF SPECIFIC EMBODIMENTS

The present invention, in some embodiments thereof, relates to compositions for solid freeform fabrication (SFF) and, more particularly, but not exclusively, to compositions useful in three-dimensional printing.

Many such compositions include a photo-initiator, which initiates a polymerization process that hardens the composition. The use of photo-initiator is advantageous, at least because a composition containing it does not cure as long as the composition is kept in the dark. On the other hand, curing may easily be achieved during manufacture, by exposure to UV or V is (visible) radiation, which the photo-initiator absorbs, and as a result, initiates the curing process.

However, photo polymerization of ethylene compounds results in a yellowish end product, and the inventors tried to overcome this problem to make clear, less yellow cured compositions by photo polymerization of ethylene compounds.

Thus, an aspect of some embodiments of the invention is a composition for 3D printing or other SFF process, which comprises a photo-initiator, hardens quickly only upon exposure to ultraviolet (UV) or visible (Vis) radiation, but with improved color (that is, less yellow than, for example, a composition marketed by Objet Geometries Ltd. under the trade name FullCure®720). In some embodiments, the requirement to harden quickly only upon exposure to UV or V is radiation means that in the absence of radiation, where the composition is stored and/or held in sealed, opaque cartridges, the viscosity of the composition at the SFF working temperature remains constant, within a limit of about 3 cps for at least 30 days aging at 40° C.

When the SFF is three-dimensional printing, the working temperature is typically between about 50° C. and 100° C.

The viscosity of the composition can be measured by Brookfield LVDVE viscometer equipped with a 25 mm spindle (Brookfield Engineering Laboratories, MA, USA).

It was found by the inventors of the present invention that adding about 5% of a sulfur containing compound to the composition might result in lessening the yellow color of the material, however, such addition also results in reduced stability (for example, a rapid increase in viscosity) of the composition, to the extent that replacing a first cartridge of material with a second cartridge of the same material that was manufactured a few days apart from the first, might necessitate calibration of the printing machine, due to the differences in viscosity of the compositions.

It was also found by the inventors that using less photo initiators results in stronger cured material.

It was surprisingly found that a minute amount of sulfur-containing compound, defined as less than X % of the composition, where X equals 4 or 3.5 or 3 or 2.5 or 2.0 or 1.5 or 1.0 or 0.5 or less, for example, 1% of the composition, is sufficient to reduce the yellow color. The lowest concentration of sulfur-containing additive in compositions according to the invention is optionally from about 0.1% to about 0.25%.

These findings of the present inventors are not yet completely understood.

In some embodiments, the composition includes polymerizable components, together with: (i) a reduced amount of photo-initiator, and (ii) the minimal amount of sulfur-containing additive required to achieve satisfactory photo curing of the composition.

As used herein, the term “reduced amount” refers to an amount that would not cure the composition satisfactorily in the absence of the sulfur-containing additive.

As used herein, “satisfactory curing” refers to curing that allows SFF with a resolution that is at least sufficient to distinguish between cured three-dimensional features (e.g., linear features, about 1 mm in thickness) that are less than X mm apart, where X equals 0.3 or 0.29 or 0.28 or 0.27 or 0.26 or 0.25 or 0.24 or 0.23 or 0.22 or 0.21, under normal operation conditions of the SFF apparatus for example, the 3D printer. Such high fee-form fabrication resolution is advantageous since it facilitates a more finely detailed and accurate final object.

The composition of the present embodiments can be characterized in terms of its reactivity. The reactivity is a measure that quantifies the ability of the composition to maintain fine details following curing. The reactivity is typically expressed in percentage where 0% corresponds to a composition that provides the lowest post-curing and 100% corresponds to a composition that provides the highest post-curing resolution for a given SFF apparatus and given operation condition. An acceptable reactivity test for compositions for three-dimensional printings is the “Menifa” test described below. The minimum acceptable level of reactivity, i.e the minimum level of reactivity at which a composition is suitable for use in three-dimensional printing is at least 30%.

In an exemplary embodiment, the 3D printer is an Eden 500V system manufactured by Objet Geometries Ltd, Israel, and the normal operation conditions are the conditions at which the system operates, in Eden High Quality printing mode.

In some embodiments, more than one photo-initiator is used. For example, two photo-initiators are used, a first for appropriate surface curing, and a second, for appropriate bulk curing of composition. Optionally, such a mixture of photo-initiators is used together with a sulfur-containing component.

It should be understood that the exact concentration of the different components of the present invention are a function of the lamp, e.g., lighting or radiation source used and the exposure conditions.

Before explaining at least one embodiment of the invention in detail, it is to be understood that the invention is not necessarily limited in its application to the details of the components, additives, system and/or methods set forth in the description, drawings and/or the Examples. The invention is capable of other embodiments or of being practiced or carried out in various ways.

The present invention is useful, for instance, in processes and compositions as taught in, for example. U.S. Pat. No. 7,300,619 (hereinafter patent '619) and in other patents and applications of the inventor as listed herein and incorporated herein by reference in their entirety, according to which the three dimensional object is built from two main compositions, referred to herein and in patent '619 as first and second interface materials. Optionally, coloring of the first interface material is improved as described herein.

In some embodiments, a composition of improved color according to an embodiment of the present invention is used as a first interface material in the same printing process as and/or together with a composition as described in patent '619 under the heading of “second interface material”. When used in combination, the proportion between the first and second compositions is preferably from about 75:25 to about 95:5, for example 90:10. The first interface material is interchangeably referred to herein as a “modeling material”, and the second interface material is interchangeably referred to herein as a “support material.”

The compositions of the first interface material or “modeling material” will be described in further detail below. The compositions of the second interface material or “support material” are in accordance with the description provided in U.S. Pat. No. 7,300,619, under the heading “second interface material”.

In some embodiments, the composition for use in the manufacture of the three-dimensional objects, i.e., the modeling material or materials, includes at least one reactive component, at least one photo-initiator, at least one surface-active agent and at least one stabilizer. The modeling material composition may be formulated so as to be compatible for use with ink-jet printers and to have a viscosity at room temperature of above 50 cps, wherein the viscosity is measured as further detailed hereinabove.

The three-dimensional object of the present invention may be built using, for example, a three-dimensional printing system similar to various embodiments of U.S. Pat. Nos. 6,658,314, 7,604,768 and 7,500,846, and PCT Publication No. WO 2009/013751, all assigned to the Assignee of the present application and incorporated herein by reference, although other suitable three-dimensional printers may be used. The system can comprise a cartridge for holding the composition of some embodiments of the present invention.

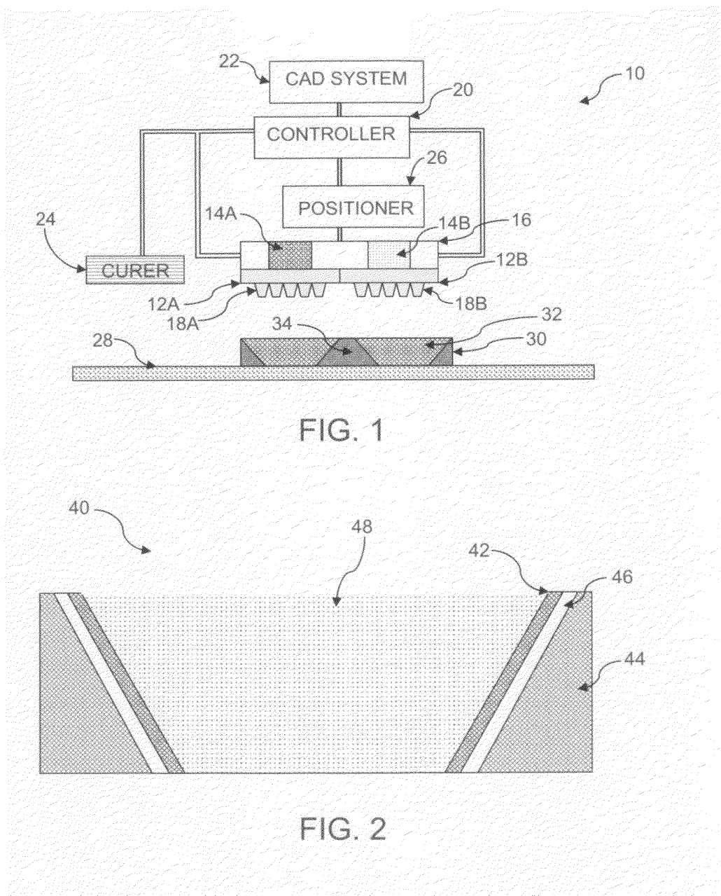

A three-dimensional printing system is shown in FIG. 1, to which reference is now made. FIG. 1 is an illustration of a three-dimensional printing system, generally designated 10, which includes a printing block 16, comprising two or more printing heads, referenced 12 and individually referenced 12A and 12B, and at least two reservoirs or dispensers generally referenced 14, each containing a different building material, and individually referenced 14A (modeling material) and 14B (support material). Other components, and other sets of components, may be used.

Printing heads 12 each have a plurality of ink-jet type nozzles, generally referenced 18, through which building materials 14A and 14B are jetted. In one embodiment of the present invention, the first dispenser containing modeling material 14A is connected to a first set of nozzles, referenced 18A, and the second dispenser containing support material 14B is connected to a second set of nozzles, referenced 18B. Thus modeling material 14A is jetted through nozzles 18A, and support material 14B is jetted through nozzles 18B. Optionally, in some embodiments (not shown), the three-dimensional printing system includes more than two printing heads, each printing head being connected to a dispenser containing a modeling material or a support material, and controllable to jet the material contained in the relevant dispenser via the printing head's nozzles. Optionally more than one modeling material is used, each modeling material being dispensed separately using a different dispenser and printing head.

The three-dimensional printing system 10 further includes a controller 20, a Computer Aided Design (CAD) system 22, curer or curing unit 24, and optionally a positioning apparatus 26. The controller 20 is coupled to the CAD system 22, curing unit 24, positioning apparatus 26, printing heads 12 and each of the dispensers containing building materials 14. Control may be affected by other units than shown, such as one or more separate units.

The three-dimensional object being produced (30) is built in layers using one or more modeling materials, shown schematically at 14A, the depth of each layer typically being controllable by selectively adjusting the output from each of the ink-jet nozzles 18A.

By combining or mixing modeling materials from each modeling material containing dispenser, wherein each dispenser contains a material having different properties, e.g., a mechanical property, the properties of the mixed material forming the three-dimensional object are adjusted and controlled. For example, where the mechanical properties of each modeling material are hardness or elasticity, different parts of the three-dimensional object may be produced to have different moduli of elasticity or different strengths, by selectively jetting different modeling materials from each modeling material containing dispensers.

As used hereinafter, the term “strength” is used as a relative term to indicate the difference in modulus of elasticity among modeling materials. The strength of a material may be described, for example, by reference to its modulus of elasticity, which may be defined as: “the ratio of stress to its corresponding strain under given conditions of load, for materials that deform elastically, according to Hooke's law”.

In accordance with one embodiment of the present invention, the first material containing dispenser 14A contains a modeling material, referred to herein interchangeably as the “first interface material”, “first building material”, or “first composition”, and the second material containing dispenser 14B contains a second material, a support material, referred to herein interchangeably as the “second interface material”, “second building material” or “second composition”.

The first building material generally has a different (harder) modulus of elasticity and a greater strength than the second building material. By using the first building material and the second building material, alone or in combination in different parts of a layer, layers of the three-dimensional object having a different moduli of elasticity and different strengths in different parts of the layer may be produced; for example, a model or “construction” layer or layer part (otherwise known as a model construction), a support layer or layer part (otherwise known as a support construction) and a release layer or layer part (otherwise known as a release construction), as defined herein below. In accordance with embodiments of the present invention, each layer of materials deposited by the apparatus during the printing process, may include a combination of model constructions, support constructions and/or release constructions, according to the requirements of the three-dimensional object being printed. Thus, when referring herein to construction layers, support layers and/or release layers, any or all of these may be part or parts comprising a single whole ‘layer’ printed by the printing apparatus during the printing process.

For example, depositing the first building material or more than one first building material (i.e. more than one modeling material) forms a multiplicity of construction layers, which are defined as the layers constituting the three-dimensional object. Multiplicity, as used hereinafter, refers to a number which is one or greater.

Further, combining the first building material and the second building material in a predetermined formation within the layer, forms a multiplicity of support layers, which are defined as the layers supporting the three-dimensional object, and not constituting the three-dimensional object.

Further, using the second building material alone may form a multiplicity of release layers, which are defined as the layers or the release construction for separating the three-dimensional object layers (model construction or object) from support layers (support construction). The release layers typically have a lower modulus of elasticity and a lower strength than the construction layers and the support layers.

In this way, the construction layers or layer parts accumulate to form a three-dimensional object, and the support layers or layer parts accumulate to form one or more support constructions. The release layers or layer parts are positioned between the construction layer parts and the support layer parts, and accumulate to form a release construction used to separate the three-dimensional object from its support construction/s upon completion of the building process.

In one embodiment of the present invention, the support layers have a lower modulus of elasticity and a lower strength than the construction layers. The support layers may be separated from the construction layers by taking advantage of their weaker properties, as will be explained in detail below. Alternatively, the support layers may be separated from the construction layers by positioning release layers between the construction layers and the support layers.

In one embodiment of the present invention, the support layers are designed substantially exactly as the construction layers, and thus have substantially the same modulus of elasticity and substantially the same strength as the construction layers.

In order to more clearly define the present invention, reference is now made to FIG. 2, which is a schematic cross-sectional view of a model of a bowl 40. This three-dimensional model is printed using the ink-jet type printing system of FIG. 1, by depositing the first interface material and the second interface material in layers, alone and/or in combination, to form a multiplicity of construction layers which make up, respectively, the bowl 42, i.e. the model or object, its support constructions 44 and thin release constructions 46.

The construction layers 42 of bowl 40 consisting of layers of modeling material, need to be supported externally, such as in the areas referenced 44. Furthermore, the internal void of the bowl, referenced 48, does not require to be “filled” during printing of the bowl, and nor does it require to be supported during printing. However, in cases where an internal void needs to be formed during printing, such as when additional construction layers, i.e. layers forming part of a final object would be required to be printed above a “void”, a multiplicity of support layers such as those indicated as 44, would be formed by combining the first interface material and the second interface material, to provide a support structure for subsequent printing of construction layers. A combination of the first building material and the second building material forms a multiplicity of support layers 44. Release layers 46 are formed between construction (model) layers 42 and support layers 44. Generally, release layers 46 have a different (lower) modulus of elasticity than support layers 44 and model layers 42, being formed only from the second building material, and thus release layers 46 may be used to facilitate separation of support layers 44 from model layers 42.

The present invention, which will now be described in detail, provides compositions suitable for use as building materials.

In some embodiments of the present invention, the first building material and second building material of the present invention are especially designed and formulated for the process of building a three-dimensional object using three-dimensional printing. Accordingly, in accordance with an embodiment of the present invention, the first building material and the second building material each have a first viscosity at room temperature, and a second viscosity compatible with ink-jet printers at a second temperature, which may be the same or different, wherein the second temperature is higher than room temperature, which is defined as about 20-30° C.

In one embodiment of the present invention, the first and the second building materials are designed to have increased viscosity at room temperature, which is defined as about 20-30° C. In another embodiment, both the first and second building material have a viscosity greater than 50 cps at room temperature. In another embodiment, the viscosity may be between 80 and 300 cps. In another embodiment, the first and the second building material may have a viscosity of around 300 cps at room temperature.

In one embodiment of the present invention, the first building material and the second building material may have a second viscosity compatible with ink-jet printing, at a second temperature which may be higher than room temperature. In another embodiment, a composition compatible with ink-jet printing may have a low viscosity, for example, below 20 cps at the printing temperature, in order to function properly in the printing process. In another embodiment, the first building material and the second building material, upon heating, have a viscosity preferably below 20 cps that may enable the construction of the three-dimensional object under heat. In one embodiment of the present invention, the temperature typically used to build the three-dimensional model of the present invention is higher than 60° C. In another embodiment, the temperature may be about 85° C. In one embodiment of the present invention, the first and second building materials may have a viscosity of 8-15 cps at a temperature greater than 60° C. In another embodiment, the first and second building materials may have a viscosity of 11 cps at a temperature of about 85° C.

Having this viscosity, the first and second building materials in one embodiment may be distinguished from prior art formulations designed for two dimensional ink-jet printing, which have low viscosity at room temperature, the temperature at which the printing is normally conducted. High viscosity at room temperature is a desirable property for three-dimensional objects, a feature that is lacking in the prior art formulations. Of course, other embodiments may have other viscosities.

The first building material (typically, the model material) is a composition suitable for building a three-dimensional object. The composition is optionally formulated to provide, after curing, a solid material. In one embodiment, curing of the composition results in a solid material, with mechanical properties that permit the building and handling of that three-dimensional object. In another embodiment, curing the composition results in a solid elastomer-like material, with mechanical properties that permit the building and handling of the three-dimensional object.

In some embodiments, the modeling material comprises a reactive component, a photo-initiator, and a sulfur-containing component. Optionally, the modeling material also comprises a surface active agent. Optionally, the modeling material is substantially free of stabilizers, other than those originating in the commercially available starting materials. This is sometimes a preferred option, as some stabilizers contribute to undesired coloration, and are inefficient in stabilizing a composition that contains a sulfur-containing additive. In addition commercially available raw materials already contain stabilizers.

In an exemplary embodiment, the first building material has a first viscosity of about 50-500 cps at ambient temperature, and a second viscosity lower than 20 cps at a temperature higher than the ambient temperature, and the cured composition is solid.

Some optional ranges for the ambient temperature are: between 20-30° C., between 10-40° C., between 15-35° C., and between 20-30° C.

Exemplary values of temperatures higher than ambient include: at least 40° C., at least 50° C., at least 60° C. and at least 70° C.

Exemplary reactive components include a mono-functional (meth)acrylic monomer, a poly-functional (meth)acrylic monomer (that is, a monomer having two or more meth(acrylic) functional groups), a (meth)acrylic oligomer, or any combination thereof, for example, a combination of a mono-functional monomer and a di-functional oligomer.

Optionally, the mono-functional acrylic monomer produces upon curing a high Glass Transition Temperature (Tg) polymer. Optionally, the di-functional oligomer produces upon curing a low Glass Transition Temperature polymer. The term Glass transition temperature (Tg) is defined as the temperature at which a polymer changes from hard and brittle to soft and pliable material.

The Glass Transition Temperature of the polymerized mono-functional acrylic monomer is optionally higher than 60° C., optionally higher than 70° C., optionally in the range of 70-110° C.

The Glass Transition Temperature of the polymerized di-functional oligomer is optionally lower than 40° C., optionally lower than 30° C., optionally in the range of 20-30° C.

In an exemplary embodiment the Glass Transition Temperature of the polymerized mono-functional acrylic monomer is higher than 60° C. and the Glass Transition Temperature of the polymerized di-functional oligomer is lower than 40° C.

In one embodiment of the present invention, the composition may include at least 20% of the high Glass Transition Temperature mono-functional monomer. In another embodiment, the composition may include at least 30% of the high Glass Transition Temperature mono-functional monomer. In another embodiment, the composition may include at least 50% of the high Glass Transition Temperature mono-functional monomer. In another embodiment, the composition may include between 20-50% of the high Glass Transition Temperature mono-functional monomer. In another embodiment, the composition may include between 30-60% of the high Glass Transition Temperature mono-functional monomer.

In one embodiment of the present invention, the composition may include about 20% of the low Glass Transition Temperature di-functional oligomers. In another embodiment, the composition may include about 40% of the low Glass Transition Temperature di-functional oligomers. In another embodiment, the composition may include between 20-40% of the low Glass Transition Temperature di-functional oligomers. In another embodiment, the composition may include at least 20% of the low Glass Transition Temperature di-functional oligomer. In another embodiment, the composition may include not more than 40% of the low Glass Transition Temperature di-functional oligomer.

In one embodiment of the present invention, the composition may include at least 40% of the high Glass Transition Temperature mono-functional monomers and at least 20% of the low Glass Transition Temperature di-functional oligomer.

In one embodiment of the present invention, the composition may include at least 20% of the high Glass Transition Temperature mono-functional monomers and not more than 40% of the low Glass Transition Temperature di-functional oligomer.

A (meth)acrylic monomer is a functional acrylated or methacrylated molecule which may be, for example, esters of acrylic acid and methacrylic acid. Monomers may be mono-functional or multi-functional (for example, di-, tri-, tetra-functional, and others). An example of an acrylic mono-functional monomer is phenoxyethyl acrylate, marketed by Sartomer under the trade name SR-339. An example of an acrylic di-functional monomer is propoxylated (2) neopentyl glycol diacrylate, marketed by Sartomer under the trade name SR-9003.

A (meth)acrylic oligomer is a functional acrylated or methacrylated molecule which may be, for example, polyesters of acrylic acid and methacrylic acid. Other examples of acrylic oligomers are the classes of urethane acrylates and urethane methacrylates. Urethane-acrylates are manufactured from aliphatic or aromatic or cycloaliphatic diisocyanates or polyisocyanates and hydroxyl-containing acrylic acid esters. An example is a urethane-acrylate oligomer marketed by Cognis under the trade name Photomer-6010.

A poly-functional (meth)acrylic monomer is a molecule which may provide enhanced crosslinking density. Examples of such molecules include Ditrimethylolpropane Tetra-acrylate (DiTMPTTA), Pentaerythitol Tetra-acrylate (TETTA), Dipentaerythitol Penta-acrylate (DiPEP). In one embodiment of the present invention, the composition may further include, inter alia, a curable component, which is a molecule having one or more epoxy substituents, a molecule having one or more vinyl ether substituents, vinylcaprolactam, vinylpyrolidone, or any combination thereof. In one embodiment of the present invention, the composition may further include, inter alia, vinylcaprolactam. Other curable components may also be used.

The modeling material may also include a curable component which is, for example, a molecule having one or more vinyl ether substituents. In one embodiment of the present invention, the concentration of component that includes a molecule having one or more vinyl ether functional groups is in the range of 10-30%. In another embodiment, the concentration is 15-20%. In another embodiment, the concentration is 15%. Of course, other concentrations, and other ranges, can be used. Conventional vinyl ether monomers and oligomers which have at least vinyl ether group are suitable. Examples of vinyl ethers are ethyl vinyl ether, propyl vinyl ether, isobutyl vinyl ether, cyclohexyl vinyl ether, 2-ethylhexyl vinyl ether, butyl vinyl ether, ethyleneglycol monovinyl ether, diethyleneglycol divinyl ether, butane diol divinyl ether, hexane diol divinyl ether, cyclohexane dimethanol monovinyl ether and the like. An example of a vinyl ether for the present invention is 1,4 cyclohexane dimethanol divinyl ether, marketed by ISP under the trade name CHVE.

In one embodiment of the present invention, the curable component of the modeling material (first building material) includes, inter alia, an acrylic monomer, an acrylic oligomer. In another embodiment, the curable component of the first building material includes an acrylic component as defined hereinabove and a molecule having one or more vinyl ether functional groups as defined hereinabove

The photo-initiator of the first interface material and of the second interface material may be the same or different, and is optionally a free radical photo-initiator.

The free radical photo-initiator may be compounds that produce a free radical on exposure to radiation such as ultraviolet or visible radiation and thereby initiates a polymerization reaction. Non-limiting examples of some suitable photo-initiators include benzophenones (aromatic ketones) such as benzophenone, methyl benzophenone; acylphosphine oxide type photo-initiators such as 2,4,6-trimethylbenzolydiphenyl phosphine oxide (TMPO), 2,4,6-trimethylbenzoylethoxyphenyl phosphine oxide (TEPO); benzoins and bezoin alkyl ethers such as benzoin, benzoin methyl ether and benzoin isopropyl ether and the like. Examples of photo-initiators are alpha-amino ketone, marketed by Ciba Specialties Chemicals Inc. (Ciba) under the trade name Irgacure 907 and alpha hydroxyl ketones—Irgacure 184 and Irgacure 2959.

In an exemplary embodiment of the present invention, the first building material also includes a sulfur-containing additive. The sulfur containing additive is optionally selected from the group consisting of beta mercaptopropionate, mercaptoacetate, alkane thiols or any combination thereof. Some examples of beta mercaptopropionate are: glycol di (3-mercaptopropionate), pentaerythritol tetra (3-mercaptopropionate), and trimethylol propane tri (3-mercaptopropionate).

The addition of sulfur-containing additive may significantly enhance the reactivity of the composition, but at the same time, may cause a reduction in stability of the composition at some concentrations.

A composition according to a preferred embodiment of the invention comprises 40-60% mono-functional acrylic monomer, 15-30% bi-functional urethane acrylic compound, 15-30% bi-functional acrylic compound, 0.25-4% sulfur-containing component, 0.5%-3% photo initiator, and the remainder other curable components, surface active agents, or other components described herein according to the intended properties of the composition.

In one embodiment of the present invention, the composition suitable for building a three-dimensional object, further includes, inter alia, a low molecular weight polymer. An example of a low molecular weight polymer for the present invention is Styrene-Butadiene-Methacrylate block copolymers (KRATON D), manufactured by Dow Corning. Other suitable substances may be used.

In one embodiment of the present invention, the composition suitable for building a three-dimensional object, further includes, inter alia, a filler.

The term filler is defined as an inert material added to a polymer, a polymer composition or other material to modify their properties and/or to adjust quality of the end products. The filler may be an inorganic particle, for example calcium carbonate, silica and clay. Of course other filler substances may be used.

Fillers may be introduced in to polymer compositions in order to reduce shrinkage during polymerization or during cooling, for example to reduce the coefficient of thermal expansion, increase strength, increase thermal stability reduce cost and/or adopt theological properties. The use of standard fillers has also some drawbacks such as reduction of elasticity and an increase in viscosity. Additionally, large diameter fillers (>5 micron) are not appropriate for ink-jet applications.

Nano-particles fillers are especially useful in applications requiring low viscosity such as ink-jet applications. Compositions containing as much as 30% nano-particle fillers are feasible, whereas the same concentration of more standard and higher diameter fillers (˜>1 micron) produce at such concentration viscosities which are too high for ink-jet applications. In one embodiment of the present invention, the nano-particle filler containing composition is clear. The composition is clear (e.g., transparent) since it contains no visual fillers. In contrast, compositions containing more standard and higher diameter visible fillers (˜>1 micron), are not clear.

In one embodiment of the present invention, the composition optionally may contain pigments. In a further embodiment of the present invention, the composition optionally may contain dyes.

In another embodiment, the pigment concentration may be lower than 35%. In another embodiment, the pigment concentration may be lower than 15%. And also lower than 1%.

In one embodiment of the present invention, the filler may include particles such as particles having an average diameter of less than 100 nm. In another embodiment, the filler may include particles having a diameter in the range of 10-100 nm. In another embodiment, the filler may include particles having a diameter in the range of 20-80 nm.

In another embodiment, the filler may include particles having a diameter in the range of 10-50 nm. In another embodiment, the filler may include particles having a diameter smaller than 10 nm. Examples of fillers that may be used in the composition are HIGHLINK OG (particle size spanning between 9 nm to 50 nm), manufactured by Clariant, and NANOCRYL (particle size below 50 nm), manufactured by Hanse Chemie. Other suitable substances may be used

In one embodiment of the present invention, the first viscosity is about 80-500 cps. In another embodiment, the first viscosity is about 300 cps. Of course, compositions having other viscosities may be used.

In one embodiment of the present invention, the second viscosity is lower than 20 cps and wherein the second temperature is higher than 60° C. In another embodiment, the second viscosity is between 10 and 17 cps and wherein the second temperature is higher than 60° C. In another embodiment, the second viscosity is between 10 and 17 cps and wherein the second temperature is about 70-110° C. In another embodiment, the second viscosity is between 12 and 15 cps and wherein the second temperature is about 70-90° C. Of course, compositions having other viscosities may be used.

Other components of the first interface material and the second interface material of the present invention are surface-active agents. A surface-active agent may be used to reduce the surface tension of the formulation to the value required for jetting or for printing process, which is typically around 30 dyne/cm. Examples of surface-active agents for the present invention are silicone surface additives, marketed by Byk Chemie under the trade name Byk.

Non-limiting examples of formulations of modeling material are provided herein below in Tables 1-2, to which reference is now made. The individual substances, suppliers, combinations, etc., are given by way of example only.

TABLE 1
Examples of Characteristic Formulation Components of
First Interface Material

| | Trade name of | | |
|---|---|---|---|
| # | components | Description | Manufacturer |
| A | PH4025 | Bisphenol A ethoxylated | Cognis |
| | | diacrylate | |
| B | PH4028F | bisphenol a ethoxylated | Cognis |
| | | diacrylate | |
| C | SR368 | tris (2-hydroxy ethyl) | Sartomer |
| | | isocyanurate triacrylate | |
| D | SR499 | ethoxylated (6) | Sartomer |
| | | trimethylolpropane triacrylate | |
| E | SR601 | ethoxylated (4) bisphenol a | Sartomer |
| | | diacrylate | |
| F | Genomer 4297 | aliphatic urethane | Rahn |
| | | dimethacrylate | |
| G | SR9036 | ethoxylated (30) bisphenol a | Sartomer |
| | | dimethacrylate | |
| H | PH6010 | aliphatic urethane acrylate, | Cognis |
| | | olygomer | |
| I | PH6230 | aliphatic urethane acrylate | Cognis |
| | | olygomer | |
| J | BR970 | difunctional aliphatic urethane | Bomar Specialties |
| | | acrylate | Co. |
| K | PH6891 | Difunctional aliphatic | Cognis |
| | | urethane acrylate | |
| L | GDMP | glycol di (3-mercaptopropionate) | Bruno Bock |
| | | | Chemische Fabrik |
| | | | GmbH&Co |
| M | PETMP | pentaerythritol tetra (3- | Bruno Bock |
| | | mercaptopropionate) | Chemische Fabrik |
| | | | GmbH&Co |
| N | TMPMP | trimethylol propane tri (3- | Bruno Bock |
| | | mercaptopropionate) | Chemische Fabrik |
| | | | GmbH&Co |
| O | SR506 | isobornyl acrylate | Sartomer |
| P | SR238 | 1,6 hexanediol diacrylate | Sartomer |
| Q | Irgacure 184 | photo initiator | Ciba |
| R | Irgacure | photo initiator | Ciba |
| | 2959 | | |
| S | Irgacure 819 | photo initiator | Ciba |
| T | Darocure | photo initiator | Ciba |
| | TPO | | |

TABLE 2
Examples of Possible Formulation Compositions of First Interface Material

| | 1 | 2 | 3 | 4 | 5 | 6 | 7 | 8 | 9 | 10 | 11 | 12 | 13 | 14 | 15 | 16 | 17 | 18 | 19 | 20 |
|---|---|---|---|---|---|---|---|---|---|---|---|---|---|---|---|---|---|---|---|---|
| A | | | X | | | | X | X | X | | | | | | | | | | | |
| B | X | X | X | | X | | | | | X | | | | | | | | | | |
| C | | | | | | | | X | X | | X | | X | | X | | X | | | |
| D | | | | | | | | | X | | X | | X | | X | | X | X | X | X |
| E | | | | X | | X | | | | | | | | | | | | | X | |
| F | | | | | X | | | | | | | | | X | X | | | | | |
| G | | | | | | | | | | | | | | | | | | X | | X |
| H | | | | | | X | X | X | X | | | | | | | | | | X | X |
| I | | | | | | | | | | | | X | X | | | | | | | |
| J | X | X | X | X | | | | | | X | | | | | | | | | | |
| K | | | | | | | | | | | X | | | | | | | | | |
| L | X | | | | | | | | | | | | | | | X | X | | | |
| M | | X | | | | | X | | | | X | | X | | | | | X | | X |
| N | X | | X | X | X | X | | X | X | X | | X | | X | X | X | X | | X | |
| O | X | X | X | X | X | X | | X | | X | X | X | X | X | X | X | X | | X | X |
| P | | | | | | | X | X | X | | | | X | | | X | | X | | |
| Q | X | X | X | X | X | X | | | X | X | | X | | X | | X | | | X | X |
| R | | | | | | X | X | X | | | X | X | X | | X | X | X | X | | |
| S | | | | | | | X | X | X | | X | | | X | | | | X | X | |
| T | X | X | X | X | X | X | X | X | X | X | X | X | X | | X | X | X | | | X |

Various embodiments and aspects of the present invention as delineated hereinabove and as claimed in the claims section below find experimental support in the following example.

### Exemplary Evaluation of Reactivity

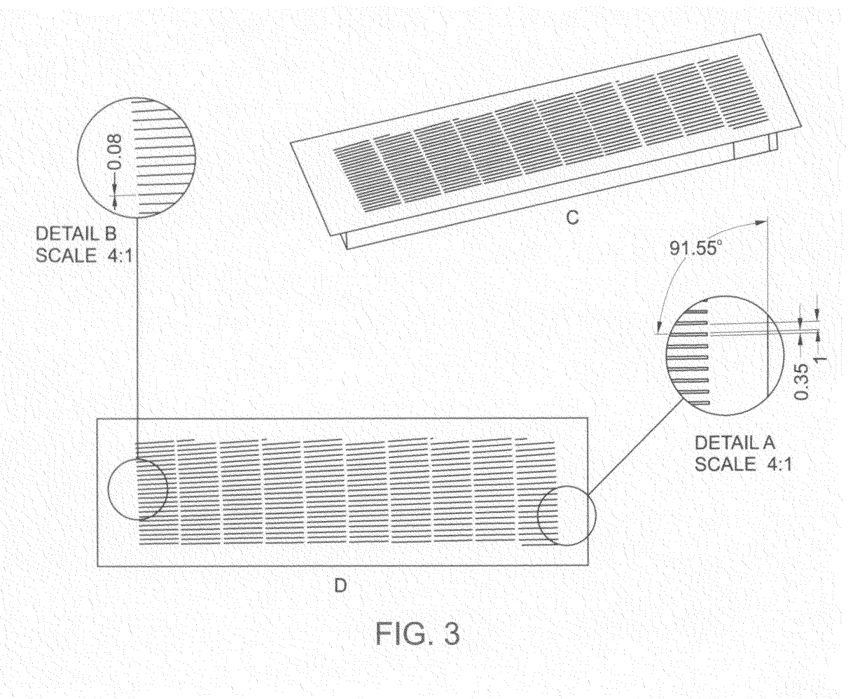

Throughout this specification, reactivity is referred to several times quantitatively. These quantitative evaluations of reactivity were done using the “Menifa test”, explained in the following paragraphs and as exemplified in FIG. 3.

The “Menifa test” is carried out by printing (building) a pattern consisting of a set of thin (1 mm in thickness) walls, having between them an angle that creates a gap which increases from 0.08 mm on one side (left side of FIG. 3) to 0.35 mm on the other side (right side of FIG. 3). The set of walls is divided into ten parts, and therefore in each one of these parts the average gap increases from left to right.

FIG. 3 is a schematic illustration of an upper view of a Menifa printed with a composition of 100% reactivity.

During printing of a Menifa with a composition of a given reactivity, the narrowest gaps tend to ‘smear’ before polymerization, and only the gaps of broadest width remain open. The point at which smeared gaps first appear is indicative of the reactivity of the composition.

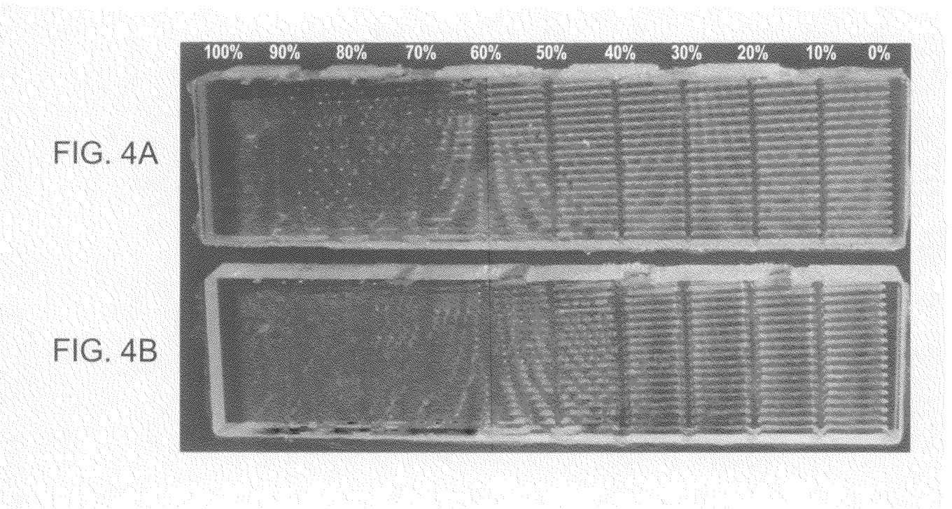

FIG. 4 is a photograph of a Menifa printed with two test compositions. The scale shows the reactivity attributed to a composition, according to the part i.e. column at which smearing begins. If smearing begins at the right-most column, having the widest gaps, reactivity of the composition is between 0% and 10%. When smearing does not appear at all, the reactivity is defined as 100%.

Thus, the composition tested in Menifa A (lower Menifa) indicates reactivity between 40% and 50%; and the composition tested in Menifa B (upper Menifa) indicates reactivity between 50% and 60%. More accurate values can be attributed by considering the amount of smearing that appears in a determine wall part. For example, if only a very small portion of the gaps in the wall section between 40% and 50% is not smeared, therefore, the reactivity is about 42%. In Menifa B, a larger portion of the gaps in the wall section between 50% and 60% are not smeared, and therefore, a reactivity of about 54% may be attributed to the tested composition.

### Examples

Reference is now made to the following examples, which together with the above descriptions illustrate some embodiments of the invention in a non-limiting fashion.

The applicants prepared many compositions with different amounts of sulfur-containing compounds to assess the effects of the various sulfur-containing compounds on reactivity and stability.

The applicants found that at low enough concentrations of photo initiators, addition of 5% sulfur containing additive (pentaerythritol tetra (3-mercaptopropionate)) significantly improves the color and reactivity of the cured composition.

Of these results, the three compositions detailed in table 3 below serve to illustrate the effect of the photo initiators and sulfur-containing additive on reactivity, color, and tensile strength. The components are listed in table 3 in the letters assigned to them in table 1. The three samples of table 3 have a substantially similar composition, except for the components indicated in the table.

TABLE 3

| | | | | Tensile |
|---|---|---|---|---|
| | | | | strength |
| Sample | Content | Reactivity | Color | MPa |
| 3D-tetra | M - 5.00% | 45% | weaker | 39 |
| | Q - 1.00% | | | |
| | T - 0.50% | | | |
| 1D | N - 5.00% | 20% | Similar to | 33 |
| | Q - 1.00% | | 3D-tetra | |
| | T - 0.50% | | | |
| 1D-11 | N - 5.0% | 35% | Stronger | 22 |
| | Q - 2.0% | | | |
| | T - 0.50% | | | |

Table 3 shows that replacing the sulfur-containing additive M with N results in reduction in reactivity and tensile strength. Increasing the amount of photo initiator Q from 1% to 2% improves the reactivity, but does not improve or lessen the color and also reduces the tensile strength. Thus, of these samples, 3D-tetra is of the best quality: it has highest reactivity, only weak color, and strong tensile strength.

However, composition 3D-tetra is still not reactive enough. The natural ways of improving the reactivity failed:

adding photo-initiator resulted in too strong a yellow hue, even in the presence of the sulfur-containing additive;

adding sulfur-containing additive resulted in too low stability; and

replacing the photo initiators with others did not yield any improvement.

Surprisingly, when the concentration of the photo-initiator was increased (to 2% Q and 0.7% T) which would be expected to worsen coloration, (increase the yellow hue in the present example), and the concentration of the sulfur-containing additive was substantially decreased (to 1% N), reactivity, color, and stability were all satisfactory. Additive M had an even stronger positive effect on color than additive N.

The mechanism by which the sulfur-containing additive lightens the color is not yet clear, but such lighter color at decreased sulfur-containing additive levels was found with all additives (L, M, and N). It is also not clear how the addition of such a minute concentration of sulfur-containing additives results in the observed improvement in reactivity.

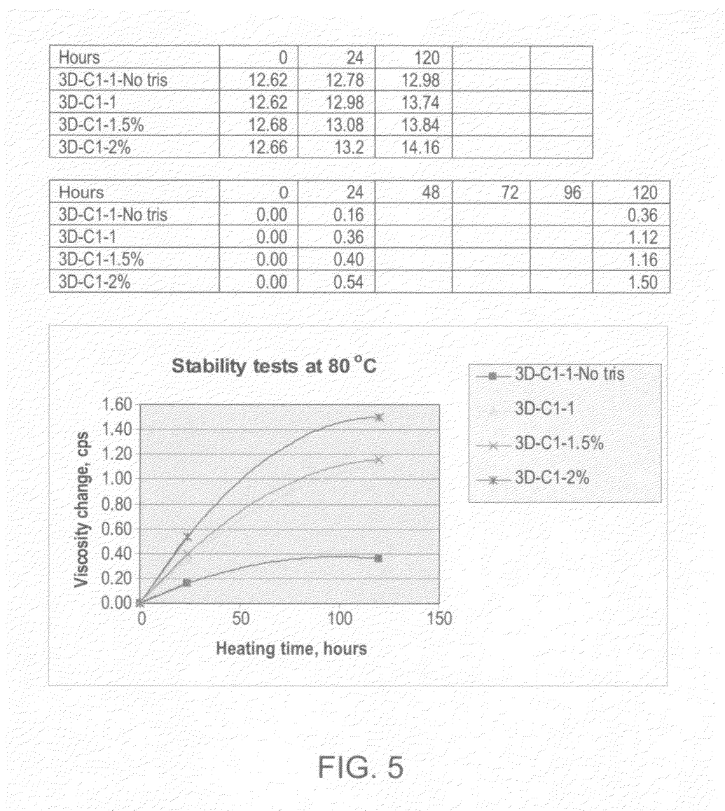

FIG. 5 is a graphic representation of the use of different percentages of sulfur containing additive (N), for comparative stability measurement. The results show stability (viscosity change in cps) of the compositions tested, over a period of 120 hours aging at 80° C. Viscosity is measured at different time points at 75° C.

In. FIG. 5, “3D-C1-1-No tris” is the base composition without the sulfur containing additive, and acts as a control. As aforementioned, the composition without the sulfur-containing additive has a significantly reduced reactivity, and is therefore less suitable for printing highly detailed models.

“3D-C1-1” is the composition with 1% N

“3D-C1-1.5” is the composition, with 1.5% N

“3D-C1-2” is the composition, with 2% N

As can be seen from the graph, of the three compositions, 3D-C1-1, i.e. composition with 1% N, is the most stable.

### General Comments

Building material—The term “building material” as used herein means, generally and collectively, materials used in the process of building or manufacturing a three-dimensional object. Building materials include “modeling materials” (referred to herein also as “first interface material” or “first material”), and “support material” or “supporting materials” (referred to herein also as “second interface material” or “second material”). One or more modeling materials are used for the building or manufacture of the three-dimensional object itself, and optionally used in a predetermined formation together with support materials, to form part of a support construction/s supporting the three-dimensional object as it is being built. Support materials are used for building support constructions to support the three-dimensional object being built, and may be used alone or together with modeling material, as aforesaid, in forming such support constructions. Support material may also be deposited alone to form a release layer between the three-dimensional object being built and the support constructions supporting it, to facilitate removal of support constructions after the printing or manufacturing process is complete.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references. For example, a disclosure of “a composition comprising a compound X” should be considered as a disclosure of a composition comprising only compound X and also as a composition comprising other compounds.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A composition for solid freeform fabrication (SFF) at a given dispensing temperature, the composition comprising:
a curable component having a (meth)acrylic functional group;
a photo-initiator, initiating polymerization of the curable component when exposed to radiation; and
a sulfur containing additive,
wherein the viscosity of the composition, as measured at said given dispensing temperature, changes by 3 cps or less during 30 days of aging at 40° C.

2. A composition according to claim 1, which is colorless before curing.

3. A composition according to claim 1, wherein the given dispensing temperature is between 40° C. and 120° C.

4. A composition according to claim 1, wherein the given dispensing temperature is between 40° C. and 90° C.

5. A composition according to claim 1, wherein said curable component is colorless before curing.

6. A composition according to claim 1, wherein the curable component is liquid at room temperature.

7. A composition according to claim 1, having viscosity of between 100 and 300 cps at room temperature.

8. A composition according to claim 1, wherein the curable component comprises a mono-functional acrylic monomer and a di-functional acrylic oligomer.

9. A composition according to claim 1, wherein the sulfur containing additive comprises a mercaptopropionate substance.

10. A composition according to claim 1, wherein the curable component comprises between 30% and 70% mono functional acrylic monomers.

11. A composition according claim 1, which upon curing provides a solid with lighter yellow hue than that of a solid obtained by curing the same composition but with less sulfur-containing additive.

12. A composition according to claim 1, wherein the sulfur containing additive constitutes up to 4% of the composition.

13. A composition according to claim 1, having a reactivity that is substantially higher than the reactivity of the same composition, but without the sulfur-containing component.

14. A composition according to claim 1, which upon curing provides a solid with tensile strength of 20 MPa or more.

15. A composition according to claim 1, which upon curing provides elastomeric material.

16. A composition according to claim 1, comprising a first photo-initiator and a second photo-initiator, wherein said first initiator absorbs longer wave UV radiation; than said second photo-initiator.

17. A method of forming a three dimensional object at a given dispensing temperature, the method comprising:
(a) dispensing a composition for solid freeform fabrication from a printing head; and
(b) curing said composition,
(c) repeating (a) and (b) until the three dimensional object is formed,
wherein said composition comprises:
a curable component having a (meth)acrylic functional group;
a photo-initiator, initiating polymerization of the curable component when exposed to radiation; and
a sulfur containing additive, and
wherein the viscosity of the composition, as measured at said given dispensing temperature, changes by 3 cps or less during 30 days of aging at 40° C.

18. A method according to claim 17, wherein the given dispensing temperature is between 40° C. and 120° C.

19. A method according to claim 17, wherein the curable component is liquid at room temperature.

20. A method according to claim 17, wherein the curable component comprises between 30% and 70% mono functional acrylic monomers.

21. A method according to claim 17, wherein the sulfur containing additive comprises a mercaptopropionate substance constituting up to 4% of the composition.

22. A method according claim 17, wherein said curing of said composition provides a solid three-dimensional object, with lighter yellow hue than that of a solid three-dimensional object obtained by curing the same composition but with less sulfur-containing additive.

23. A composition for solid freeform fabrication (SFF) comprising:
a curable component having a monofunctional group, said group being (meth)acrylic; and said curable component being at a concentration of at least 30%
a photo-initiator; and
a mercaptopropionate substance at a concentration of 4% or less,
wherein said composition is liquid and has a viscosity between 100 and 300 cps at room temperature;
wherein the viscosity of the composition changes by 3 cps or less over 30 days aging at 40° C., said viscosity being measured at a dispensing temperature of 50° C. to 90° C.; and
wherein said composition results in a solid material after UV curing.

24. A solid freeform fabrication system configured for using the composition of claim 23.

25. The system of claim 24, further comprising a cartridge for holding said composition.
